(19) United States
(12) Patent Application Publication
(10) Pub. No.: US 2004/0133627 A1
(43) Pub. Date: Jul. 8, 2004

(54) Communication system, a computer program code embodying in the communication system and methods of operating the same

(76) Inventors: Raghuraman Kalyanaraman, Bangalore (IN); Ajit Katankot, Bangalore (IN); Vidhi Rastogi, Bangalore (IN)

Correspondence Address: WELLS ST. JOHN P.S., 601 W. FIRST AVENUE, SUITE 1300, SPOKANE, WA, 99201, US

(21) Appl. No.: 10/338,803

(22) Filed: Jan. 7, 2003

(51) Int. Cl. G06F 15/16

(52) U.S. Cl. 709/201

(57) ABSTRACT

A communication system embodying a computer program code configured to process multimedia services in residential gateways and IP Phones. The computer program code is an XML based language. The communication system comprises a communication network, a call server and a plurality of Communication devices embodying a computer program code.

### FIELD OF THE INVENTION

The disclosure in general relates to telecommunication technologies. More particularly, the disclosure relates to a communications system, a computer program code embodying in the communications system and methods of operating the same.

### BACKGROUND OF THE INVENTION

Residential gateways work as gateways between communication devices like phones and faxes on one side and the network on the other. Residential gateways convert user actions happening on the part of the communication devices to corresponding digital messages on the network side. Examples for the user actions are the ‘off-hook’, ‘on-hook’, and ‘flash’ functions. A residential gateway is typically a box to which one or more communication devices are connected on one side, and the network on the other side.

In converting the user functions happening on the part of the communication devices to digital messages, the gateways employ specific communication protocols. These communication protocols specify the format of the digital messages to set up, break down or modify the parameters of a given function. Examples of this are a voice call or instant messaging. The protocols typically used include the Session Initiation Protocol (SIP) or the Media Gateway Control Protocol (MGCP).

Developing call processing applications (as for example call forward or call waiting) is a time consuming and laborious process, involving the re-compilation, the re-testing and the re-deployment of the executables through millions of already installed gateways and IP Phones. To illustrate, in a traditional residential gateway solution written in C language, the user would use C functions to create call processing features using underlying functions of the residential gateway to create and send the digital messages as mentioned above. This process is tedious and needs to be passed through a process of compilation of the C language code to binary code, and linking of the binary code called libraries with other standard libraries, to form an executable. This process freezes the logic of the call processing or messaging feature inside the executable. If the developer wants to change the logic of the call processing feature, the developer has to go through the whole process of coding in C language, compilation, linking and creating the executables repeatedly. Consequently the time taken to develop a feature is long, and the process per se becomes prone to error.

This technical problem prompted to explore the possibility of keeping the logic of the call-processing feature outside the executable and writing the same employing a representation mechanism, which could be simple like plain English, called XML. As a result, the change of the logic becomes easy. All what is required is to re-write the call processing feature logic in English, while the core logic of the residential gateway could remain in the binary format. The residential gateway and the related communication system will need a mechanism to read the XML based feature logic, understand the English like constructs of the language, and execute the logic as understood, in the underlying signaling system. The same would apply to a communication system connecting configured to connect IP Phones.

There have been many attempts to define the XML language suited for executing feature logic. One of the shortcomings of most known XML based languages is that the XML language is very descriptive and exhaustive. The underlying system, in order to understand the feature logic, needs to understand a huge array of vocabulary. Consequently the size of the system increases. Because the semantics of a construct are predefined in the language, it is not possible if one wants to change the way a particular construct is understood. Also, if a new construct needs to be added to the XML language, the system needs to be recompiled again as the underlying system is built for a fixed set of vocabulary of constructs.

It would therefore be desirable to provide systems and methods to address these and other problems.

### SUMMARY OF THE INVENTION

It is a principal aspect of the present invention to configure a communication system embodying a computer program code configurable to provide multimedia services. The communication system comprises a network, a call server, a telephone device, a control and media signaling protocol and a plurality of communication devices embodying a computer program code configurable to provide at least one of the plurality of the multimedia services selected from a group of multimedia services. The communication system is configured to implement multimedia services in residential gateways and IP Phones. The computer program code embodied in the communication system is a service processing language based on XML.

It is also a principal aspect of the present invention to configure a communications system embodying a computer program code, configurable to provide multimedia services. The multimedia services is any one selected from a group of services that comprises essentially of call forwarding, call transfer, notification service, messaging, call waiting, video conference, video and voice call, video or voice call, exchange of data during an active video and voice call, exchange of data during an active video or voice call, exchange of data during conference, third party call control and hotline services.

It is still another aspect of the present invention to provide for a communication device embodying a computer program, the device comprising a hardware layer, a network interface layer, a device layer and a service layer, the communication device configurable to implement multimedia services. The communication device thus configured is implemented in residential gateways and IP Phones to execute multimedia services.

In yet another important aspect the present invention provides for a communication device embodying computer program code configurable to provide at least one of the plurality of multimedia services. The communication device comprises a hardware layer, a network interface layer, a device layer, and a service layer, wherein the hardware layer has a serial line interface controller configured to perform loop signaling, a memory configured to host the network interface layer, the device layer and the service layer, a central processing unit configured to execute a logic contained in the network interface layer, the device layer and the service layer, a network interface controller configured to receive network events, an I/O Controller configured to receive watchdog events, a digital signal processor configured to compress and decompress voice samples, the device layer has a device manager configured to manage multiple telephone devices, a client driver configured to convert device events to software events and software events to device events, the network interface layer has a connection manager configured to manage state of connections in the communication device, a control signal protocol interface layer configured to format connection requests into a control signal protocol, a transport interface layer configured to convert control signal protocol into a network event the service layer has a Watchdog configured to initialize or shutdown a Service Manager, an SPL Script Store configured to store SPL Script, an SPL Interpreter configured to read the SPL Script stored in the SPL Script Store and convert the SPL Script into SPL Objects, an SPL Object Repository configured to store the SPL Objects, an SPL Service Manager configured to process multimedia services, an SPL Tag Function Library configured to notify the SPL Interpreter of any change in the Tag Functions wherein the communication device is configured to provide at least one of the plurality of the multimedia services selected from a group of multimedia services. The multimedia services comprises essentially of call forwarding, call transfer, notification service, messaging, call waiting, video conference, video and voice call, video or voice call, exchange of data during an active video and voice call, exchange of data during an active video or voice call, exchange of data during active conference, third party call control and hotline services. The computer program code embodied in the communication system is a service processing language based on XML.

In still another aspect, the present invention provides for a Communication System embodying a computer program code, the Communication System comprising a Service Layer having a Watchdog configured to initialize or shutdown the SPL Service Manager, an SPL Script Store configured to store SPL Script, an SPL Interpreter configured to interpret the SPL Script, an SPL Object Repository configured to store SPL Objects corresponding to the SPL Script, an SPL Service Manager configured to process multimedia services, an SPL Tag Function Library configured to notify the SPL Interpreter any change in the multimedia services wherein the Service Layer configured to enable the Communication System to process incoming device events in residential gateways.

In still another aspect, the present invention provides for a Communication System, the Communication System being an IP Phone, the System comprising a Service Layer having a Watchdog configured to initialize or shutdown the SPL Service Manager, an SPL Script Store configured to store SPL Script, an SPL Interpreter configured to interpret the SPL Script, an SPL Object Repository configured to store SPL Objects corresponding to the SPL Script, an SPL Service Manager configured to process multimedia services, an SPL Tag Function Library configured to notify the SPL Interpreter any change in the multimedia services wherein the Service Layer configured to enable the Communication System to process incoming device events.

In still another aspect, the present invention provides for a Communication System, the Communication System being an IP Phone, the System comprising a Service Layer having a Watchdog configured to initialize or shutdown the SPL Service Manager, an SPL Script Store configured to store SPL Script, an SPL Interpreter configured to interpret the SPL Script, an SPL Object Repository configured to store SPL Objects corresponding to the SPL Script, an SPL Service Manager configured to process events, an SPL Tag Function Library configured to notify the SPL Interpreter the changes in the events, wherein the Service Layer configured to enable the Communication System to process incoming network events.

It is also an aspect of the invention to configure Communication device to receive a network event, process the network event in the Service Layer resulting in a device event and transmitting the device event to a Telephone device through a device layer. The invention also provides for a Communication System configured to receive a device event, processing the device event in a Service Layer resulting in a network event and transmitting the network event to a network through a network interface layer. The invention also provides for a Communication System configured to receive a device event, processing the device event in a Service Layer resulting in a device event and transmitting the device event to a Telephone device through a Device Layer. In yet another aspect, the invention provides for a Communication System configured to receive a network event, processing the network event in the Service Layer resulting in a network event and transmitting the network event to a network through a network interface layer.

It is also an aspect of the present invention to configure an Communication System configured to receive a network event, process the network event in the Service Layer resulting in no outgoing event. The invention also provides for a Communication System configured to receive a device event, process the device event in a Service Layer resulting in no outgoing event. In yet another aspect, the invention provides for a Communication System configured to receive a device event, processing the device event in the Service Layer resulting in a network event and a device event, and transmitting the network event to a network through a Network Interface Layer, and transmitting the device event to a Telephone device through a Device Layer.

It is an aspect of the present invention to provide for a method of implementing multimedia services employing a communication system embodying a computer program code, the method comprising implementing multimedia services in residential gateways and IP Phones. The computer program code embodied in the communication system is a service processing language based on XML.

It is also an aspect of the present invention to provide for a method of processing multimedia services in residential gateways employing a Communication System embodying a computer program code. The method comprises receiving an event by a Network Interface Controller from a Network; notifying the event through Control, Address and Data Bus to a Transport Interface Layer of a Network Interface Layer, the Transport Interface Layer in conjunction with a Connection Manager and a Control and Media Signaling Protocol Layer converts the network event into a Service Layer-Network Layer Interface event, receiving the network event thus converted into a Service Layer-Network Layer Interface event by a an SPL Service Manager, extracting device-id and connection-id by an SPL Service Manager from the event; accessing an SPL Object Repository by the SPL Service Manager to identify an SPL Object corresponding to the device-id and the connection-id received from the event and generating an SPL Output Event; communicating the SPL Output Event to the Network Interface Layer, forwarding the SPL Output Event by the Network Interface Layer to the Network Interface Controller and returning the SPL Output Event by the Network Interface Controller to the Network. The computer program code embodied in the communication system is a service processing language based on XML.

It is also an aspect of the present invention to provide for a method of processing multimedia services that include pure voice and/or video based services, pure data or content based services, or services that employ both voice and/or video and data or content, typically referred to as “convergent services” in residential gateways employing a Communications System embodying a computer program code. The method comprises receiving an event by a Network Interface Controller from a Network; notifying the event through a Control, Address and Data Bus to a Transport Interface Layer of a Network Interface Layer, the Transport Interface Layer in conjunction with a Connection Manager and a Control and Media Signaling Protocol converts the network event into a Service Layer-Network Interface Layer Interface event, receiving the network event thus converted into a Service Layer-Network Interface Layer Interface event by a an SPL Service Manager extracting device-id and connection-id from the event by the SPL Service Manager; accessing an SPL Object Repository by the SPL Service Manager to identify SPL Objects corresponding to the device-id and the connection-id received from the event and generating an SPL Output Event, communicating the SPL Output Event, thus generated to the Network Interface Layer, forwarding the SPL Output Event by the Network Interface Layer to the Network Interface Controller and returning the SPL Output Event by the Network Interface Controller to the Network. The computer program code embodied in the communication system is a service processing language based on XML.

It is also an aspect of the present invention to provide for a method of processing multimedia services that include pure voice and/or video based services, pure data or content based services, or services that employ both voice and/or video and data or content, typically referred to as “convergent services” in residential gateways employing a Communication System embodying a computer program code. The method comprises receiving an event by a Serial Link Interface Controller in conjunction with a Digital Signal Processor from a Telephone device, notifying the event through a Control, Address and Data Bus to a Device Layer, the Device Layer in conjunction with a Client Driver and a Device Manager converts the device event to a Service Layer-Device Layer Interface event, receiving the device event thus converted into the Service Layer Device Layer Interface event by an SPL Service Manager, extracting device-id and connection-id by the SPL Service Manager from the event; accessing an SPL Object Repository by the SPL Service Manager to identify SPL Objects corresponding to the device-id and the connection-id received from the event and generating an SPL Output Event, communicating the SPL Output Event, thus generated to the Device Layer, forwarding the SPL Output Event by the Device Layer to the Network Interface Controller and returning the SPL Output Event by the Network Interface Controller to the Network.

It is also an aspect of the present invention to provide for a method of processing multimedia services that include pure voice and/or video based services, pure data or content based services, or services that employ both voice and/or video and data or content, typically referred to as “convergent services” in IP Phones employing a Communication System embodying a computer program code. The method comprises receiving an event by a Display Controller in conjunction with a Keypad Controller and a Converter from a Telephone device; notifies the event to a Client Driver of the Device Layer, the Device Layer in conjunction with the Client Driver and a Device Manager converts the device event into a Service Layer-Device Layer Interface event, receiving the device event thus converted into the Service Layer-Device Layer Interface event by an SPL Service Manager, extracting device-id and connection-id by the SPL Service Manager from the event; accessing an SPL Object Repository by the SPL Service Manager to identify SPL Objects corresponding to the device-id and the connection-id received from the event and generating an SPL Output Event, communicating the SPL Output Event, thus generated to the Device Layer, forwarding the SPL Output Event by the Device Layer to the I/O Controller and returning the SPL Output Event to the Network by the Network Interface Controller. The computer program code embodied in the communication system is a service processing language based on XML.

In yet another aspect, the present invention provides for a method comprising receiving device id and connection id from the events, extracting the SPL objects corresponding to the device id and connection id, processing the event in the context of the multimedia service logic contained in the SPL object, generating an event corresponding to state of the SPL object as extracted from the SPL object Repository and transmitting the event thus generated to the Device Manager or Connection Manager.

It is also an aspect of the present invention to provide for a method of implementing multimedia services that include pure voice and/or video based services, pure data or content based services, or services that employ both voice and/or video and data or content, typically referred to as “convergent services” in IP Phones employing a Communication System embodying a computer program code. The method comprises receiving an event by an I/O Controller from an external controlling entity; notifies the event to a Watchdog of the Service Layer, converting the event into a Watchdog event and transmitting it over the Watchdog-Service Manager Interface by the Watchdog, receiving the Watchdog Event thus converted by an SPL Service Manager, shutting down the SPL Service Manager if the received event is Shutdown_Service_Manager, initializing the SPL Service Manager if the received event is Initialize_Service_Manager.

It is also an aspect of the present invention to provide for a method of implementing multimedia services that include pure voice and/or video based services, pure data or content based services, or services that employ both voice and/or video and data or content, typically referred to as “convergent services” in residential gateway employing a Communication System embodying a computer program code. The method comprises receiving an event by an I/O Controller from an external controlling entity; notifies the event to a Watchdog of the Service Layer, converting the event into a Watchdog event and transmitting it over the Watchdog-Service Manager Interface by the Watchdog, receiving the Watchdog Event thus converted by an SPL Service Manager, shutting down the SPL Service Manager if the received event is Shutdown_Service_Manager, initializing the SPL Service Manager if the received event is Initialize_Service_Manager.

It is an aspect of the present invention to provide for a method comprising a first instance of the SPL Service Manager does not generating an event, a second instance of the SPL Service Manager generating an event, a third instance of the Service Manager generating an event and transmitting the event thus generated to a connection manager, a fourth instance of the SPL Service Manager transmitting the event generated to a Device Manager and a fifth instance of the SPL Service Manager generating an event and transmitting the event to the Connection Manager and the Device Manager.

In yet another aspect the present invention provides for generating a plurality of events in the event generation steps.

It is yet another aspect of the present invention to provide for communication device embodying a computer program code, the device comprising a service layer, a device layer, a network interface layer and a hardware layer wherein the service layer, the device layer and the network interface layer in conjunction with one or more components of the hardware layer configured to perform at least one of the plurality of multimedia services selected from a group of multimedia services comprising essentially of call forwarding, call transfer, notification service, messaging, call waiting, video conference, video and/or voice call, exchange of information during an active video and/or voice call or conference, third party call control and hotline service.

In yet another aspect of the present invention provides for a communication device embodying computer program code configurable to provide at least one of the plurality of the multimedia services selected from a group of services comprising essentially of call forwarding, call transfer, notification service, messaging, call waiting, video conference, video and/or voice call, exchange of information during an active video and/or voice call or conference, third party call control and hotline service

### BRIEF DESCRIPTION OF THE DRAWING FIGURES

Embodiments of the invention are described below with reference to the following accompanying drawings.

FIG. 1 is a block diagram illustrating an example environment wherein a plurality of communication devices embodying a computer program code communicate to a call server through a network.

FIG. 2 is a block diagram illustrating the various components of a communication device embodying a computer program code in accordance with embodiments of the invention.

FIG. 3 is a block diagram showing the components of a hardware layer in case of an IP Phone.

FIG. 4 is a master flow chart explaining the method of operation of a communication device embodying a computer program code in accordance with embodiments of the invention.

FIG. 5 is a flow chart explaining the operation of the Hardware Layer of a communication device embodying a computer program code in accordance with embodiments of the invention.

FIG. 6 is a flow chart explaining the operation of the Device Layer of a communication device embodying a computer program code in accordance with embodiments of the invention.

FIG. 7 is a flow chart explaining the operation of the Network Interface Layer of the communication device embodying a computer program code in accordance with embodiments of the invention.

FIG. 8 is a flowchart of creating and storing SPL scripts in a SPL Script Store in accordance with embodiments of the invention.

FIG. 9 is a flowchart of operation of a SPL Interpreter in accordance with embodiments of the invention.

FIG. 10 is a flowchart of operation of the SPL Tag Function Library in accordance with embodiments of the invention.

FIGS. 11, 12 and 13 are flow charts explaining the method of operation of a SPL Service Manager in accordance with embodiments of the invention.

FIG. 14 represents the processing of logic in an SPL Object. The flow chart describes a common execution logic, which is followed for the execution of any SPL object.

### DETAILED DESCRIPTION

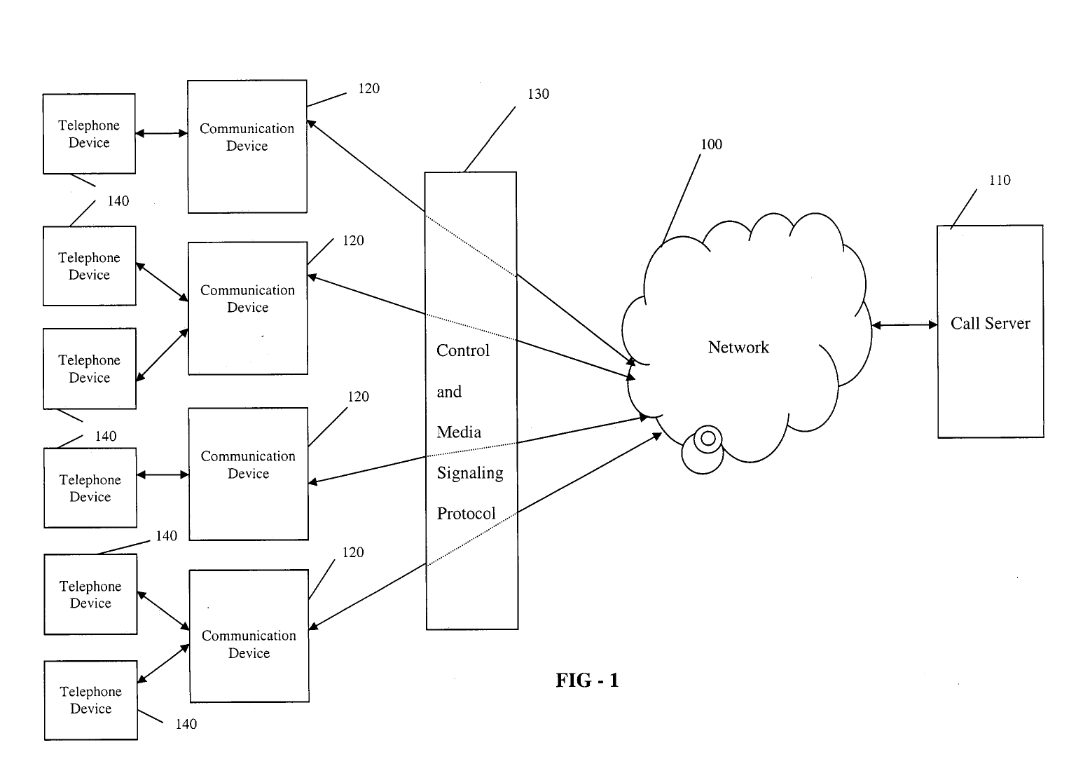

FIG. 1 illustrates components and their major interactions in a system in accordance with various embodiments of the invention. A network 100, which could be a public or a private communication network, enables communication between a call server 110 and a communication device 120 using a control and media signaling protocol 130. The device 120 could itself be a telephone device or a plurality of telephone devices 140 connected to a communication device 120. The call server 110 defines a control and media signaling protocol 130 and handles call-processing requests and responses from a plurality of communication devices 120. The control and media signaling protocol 130 is is further employed to carry requests and response to establish, modify, destroy and manage multimedia sessions and media packets from the device 120 to the network 100 and from the network 100 to the plurality of devices 120. The network 100 is implemented in some embodiments using the Internet protocol standard (IP). The network 100 can be implemented either as a point-to-point connection between the communication device 120 and the call server 110, or as several networks spanning a large geographical area or as a single homogeneous network. The network 100 can span one or more organizations and/or geographical entities. The communication device 120 operates co-operatively with a call server 110 according to a predefined control and media signaling protocol 130 (e.g., Session Description Protocol and/or Session Initiation Protocol, or Media Gateway Control Protocol of Internet Engineering Task Force) to establish, modify, destroy and manage multimedia sessions.

The communication system embodying a computer program code is configured to process multimedia services. The computer program code is an XML based language. The implementation of the multimedia service includes processing a plurality of voice events, data events and convergent events. A call is a session between one end device and at least one more end device established using the SPL script executed in the SPL Service Manager, using which video, text, or voice can be exchanged in real time or non-real time between the specified end devices. The call is uniquely identified using a Connection-ID in conjunction with one or many Device-IDs. The typical multimedia services that a communication device can be configured to perform are the following.

Call Forwarding: to forward a incoming call that has alerted a first end device, to a second end device, if the end device receiving the incoming voice or video call, is busy in another voice or video call, or is not picked up for receiving the call, or is permanently forwarded to a second end device. This is an example of a voice or video service

Call Transfer: to transfer an active incoming call from one end device to another end device, with or without the consultation of a third end device to which the call is transferred. This is an example of a voice or video service.

Notification Service: to send data regarding the end device, or missed calls, received calls, forwarded calls, outgoing calls, or regarding the state of the calls from an end device to a person using any messaging means like email, SMS (Short messaging service), text display in the end device, or interaction with any other proprietary or standard programs outside the communication system using the Network controller. The notification information could be any information regarding the end devices under communication. The notification can be automatically sent to a call server or can be transmitted on request from a call server. This is an example of convergent services.

Messaging: to send and receive any text, pictorial, or moving image data, from one end device to one or more other end devices. This is an example of a data service.

Call Waiting: to receive audio or visual notification of an incoming call from a third end device, when the specified end device is engaged in the process of communicating with a second end device. This is an example of a voice or video service

Video conference: to send and receive video and voice between three or more end devices capable of supporting both audio and video data. This is an example of a video service.

Video and/or voice call: to send and receive video or voice between two end devices capable of supporting both audio and video data. This is an example of a video and voice service.

Exchange of information during an active video and/or voice call or conference: to send data from any end device to any end device that is involved in a active video and/or voice call or conference. This is an example of a convergent service

Third party call control: to remotely configure end devices and/or control the setup, management, teardown of multimedia sessions between end devices or to send and receive data to one or more end devices from one or many call servers. This is an example of a convergent service.

Hotline service: to send and receive video or voice from a source end device to a pre-configured destination end device. The source end device in this case has no choice of dialing or communicating with any other device other than the pre-configured destination end device. This is an example of a video or voice service.

Pure voice and/or video event is a multimedia service that is based upon voice and/or video in a channel of communication as a means of exchanging information between two or more telephone devices 140. Example voice services are telephone call, call forwarding, call transfer, speed dial. An example of video service is a videoconference.

Pure data or content based event is a multimedia service that is based upon data or text based or, picture based content in a channel of communication as a means of exchanging information between two or more telephone devices 140. An example data service is instant messaging where two parties send each other text messages or pictures or video through the network using the call server.

Convergent event is a multimedia service that is based upon both voice and/or video and data or content in a channel of communication as a means of exchanging information between two or more telephone devices 140. An example convergent service is “Email notification on missed incoming call”.

The multimedia services could be segregated in the context of the present invention as a device event arising from a telephone device and a network event coming from the network.

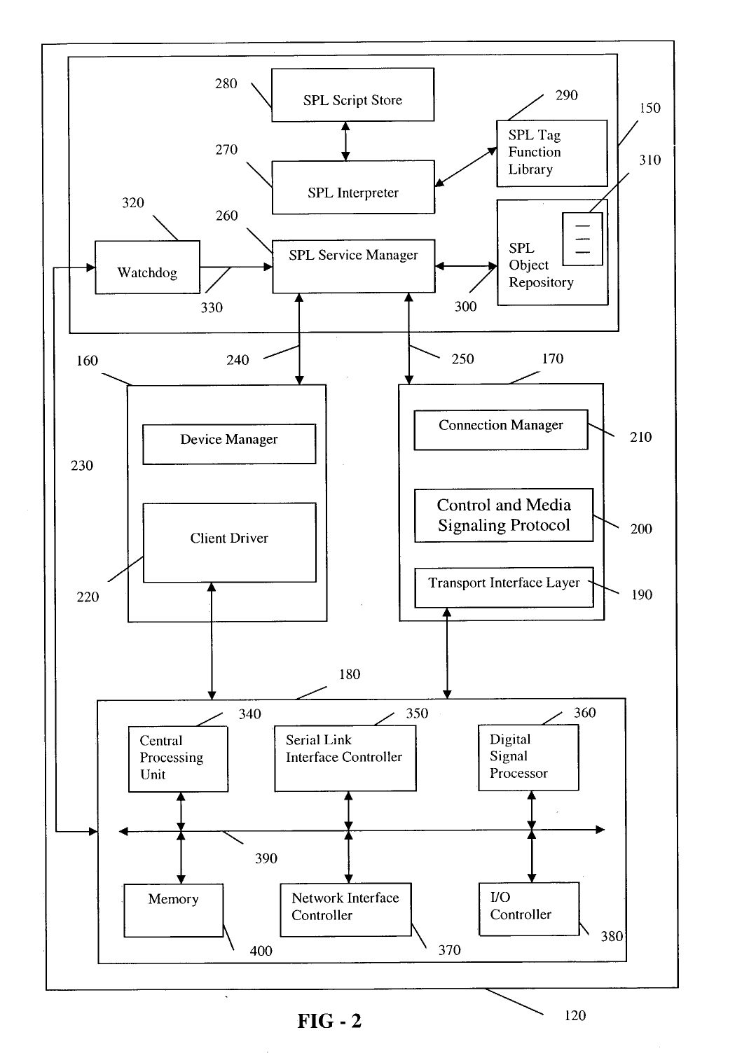

FIG. 2 illustrates the components of a Communication device 120 and their interactions in accordance with one embodiment. The device 120 has a service layer 150, a device layer 160, a network interface layer 170 and a hardware layer 180.

The network interface layer 170 houses a transport interface layer 190 configured to convert messages generated by a control and media signaling protocol layer 200 in control and media signaling protocol format into network protocol format, and sends the messages in network protocol format to the call server 110 through the network 100. The control and media signaling protocol layer 200, in operation, is in communication with the transport interface layer 190 and a connection manager 210.

The control and media signal protocol layer 200 receives, in operation, requests and/or responses to establish, modify, destroy, manage multimedia sessions, from a connection manager 210 and converts them into control and media signaling protocol 130. The control and media signaling protocol layer 200 additionally converts, in operation, control and media signaling protocol 130 messages received from the transport interface layer 190 into requests and responses to establish, modify, and destroy multimedia sessions and transmits them to the connection manager 210. The connection manager 210 can manage zero or many multimedia sessions. Each multimedia session is uniquely identified by a session identifier. The connection manager 210 manages, in operation, the state of each multimedia session. The connection manager 210, in operation, receives connection events from the service layer 150 over a service layer-network interface layer interface 250, processes the connection events and converts them to requests and/or responses to establish, modify, destroy, manage multimedia sessions and transmits the requests and/or responses to the control and media signaling protocol layer 200. The connection manager 210 also, in operation, receives requests and/or responses to establish, modify, destroy, manage multimedia sessions from the control and media signaling protocol layer 200, processes the requests and/or responses, and converts them to connection events and transmits the connection events to the service layer 150 through the service layer-network interface layer interface 250.

The device layer 160 has a software subsystem Client Driver 220 and a Device Manager 230. The client driver 220, in operation, receives one or many software commands and/or requests from the Device Manager 230, and converts them into one or many hardware commands and/or requests. The hardware commands and/or requests are sent to one or many components in the Hardware Layer 180. The components in the Hardware Layer 180 either perform one or many actions based on hardware command or retrieve information from the hardware component and send the information back to the Client Driver 220. The Device Manager 230, in operation, manages one or many Telephone Devices 140. Telephone Device 140 is uniquely identified by a device identifier. The Device Manager 230, in operation, manages the state of each End Device 140. The Device Manager 230 receives device layer events from the Service Layer 150 over the Service Layer-Device Layer Interface 240, and processes the device layer events, and converts them to one or many software commands and/or requests, and transmits the software commands and/or requests to the Client Driver 220.

The Service Layer-Device Layer Interface 240 describes device layer events transmitted and received by the Service Layer 150 from the Device Layer 160. The SPL Service Manager 260 transmits and receives the events to the Device Layer 160 and the Network Interface Layer in the Service Layer 150. The Device Manager 230 transmits and receives the device layer events to the Service Layer 150. The Service Layer-Device Layer Interface 240 defines the device layer events including an event when a call is on hook, an event when a call is offhook, an event when a call is on playtone, an event when call digits are collected, an event when call text is displayed, an event when lamp state is set, an event when key press is collected, an event when speaker mode is set, an event when microphone mode is set, an event when hook switch status is obtained, an event when hook switch status is set, an event when display is obtained, an event when button information is obtained, an event when display is set, an event when lamp information is obtained, an event when dial mode is obtained, an event when dial mode is set, an event when lamp information is set, an event when lamp mode is obtained, an event when lamp mode is set, an event when message waiting indicator is obtained, an event when message waiting indicator is set, an event when microphone gain is obtained, an event when microphone gain is set, an event when ringer status is obtained, an event when ringer status is set, an event when speaker mute is obtained, an event when speaker mute is set, an event when speaker volume is obtained, an event when speaker volume is set, an event when a call is on hold, an event when flash is opted, an event when a call is on conference, an event when a call is transferred, an event when media is allocated, an event when media is attached and an event when media is detached. The Service Layer-Device Layer Interface 240 transmits or receives zero or many of the device layer events. Each device layer event is associated with one connection-id and one device-id. Connection-id is a number or a text string or a combination of both that uniquely identifies a channel of communication established between two or more Telephone Devices 140 over the Network 100 by the Network Interface Layer 170 in conjunction with the Call Server 110. A plurality of connection-ids identify a plurality of channels of communication.

Device-id is a number or a text string or a combination of both that uniquely identifies a Telephone Device 140. A plurality of device-ids identify a plurality of telephone devices.

The Service Layer-Network Interface Layer Interface 250 describes the connection events transmitted and received by the Service Layer 150 from the Network Interface Layer 170. The SPL Service Manager 260 transmits and receives the connection events in the Service Layer 150. The Connection Manager 210 is configured to transmit and receive the connection events in the Network Interface Layer 170. The Service Layer-Network Interface Layer Interface 250 defines the connection events that include an event when a call is created, an event when a call is incoming, an event when a call is timed out, an event when an error is occurred, an event when a local party is answered, an event when a local party is alerted, an event when a call is proceeded, an event when a call is established, an event when a local party is disconnected, an event when a remote party is answered, an event when a remote party is alerted, an event when a remote party is disconnected, an event when a call is on remote hold, an event when a call is on local hold, an event when a call is transferred, an event when a call is on conference, an event when call data is obtained, an event when call data is set, an event when media is enabled, an event when media is disabled, an event when a message is sent, an event when a message is received, an event when a call is notified, an event when notification is obtained, an event when user data is obtained and an event when user data is set. The Service Layer-Network Interface Layer Interface 250 transmits or receives zero or many of the connection events. Each connection event is associated with one connection-id and one device-id.

Definition of SPL: The expression SPL used in the specification is the acronym of Service Processing Language. The service processing language is an XML based language configured to enable the communication device to process multimedia services. In the service processing language, any new construct could be easily added to the language without the need for the system to recompile. The logic of the call processing features could be kept outside the executables by using the service processing language in the communication system. The Service Layer 150 includes an SPL Service Manager 260 configured to execute, manage one or many of multimedia services, SPL Interpreter 270 configured to interpret the logic in the SPL Script, SPL Script Store 280 configured to store the SPL script, SPL Tag FunctionLibrary290 configured to store the functions corresponding to each SPL Tag, SPL Object Repository 300 configured to store one or many SPL Service Objects 310, and Watchdog 320 configured to generate events to initialize and shutdown the Service Layer 150 through the Watchdog-Service Manager Interface 330.

The Watchdog 320 generates watchdog events to initialize, and shutdown the Service Layer 150. The watchdog events are described by the Watchdog-Service Manager Interface 330. The Watchdog 320 generates the watchdog events based on the events received from the I/O Controller 360. The Watchdog-Service Manager Interface 330 describes the watchdog events received by the SPL Service Manager 260 from the Watchdog 320. The Watchdog-Service Manager Interface 330 defines the watchdog events that include Initialize_Service Manager, Shutdown_Service_Manager.

The SPL Service Manager 260 is configured to execute and manage one or many multimedia services as defined by the logic contained in an SPL Script. The SPL Service Manager 260, in operation, retrieves an SPL Service Object 310 from an SPL Object Repository 300 and creates the SPL Service Object 310. The SPL Service Object 310, in operation, stores the state, and data of a multimedia service corresponding to one or many device identifier and one or many connection identifier. The SPL Service Manager 260 reads the SPL Service Object 310 and executes the multimedia service logic stored in the SPL Service Object 310. The SPL Service Manager 260 receives device layer events from the Device Layer 160 and consumes the events, or converts them into other or same device layer events to the Device Layer 160 and/or connection events to the Network Interface Layer 170, based on the multimedia service logic, and transmits the device layer events to the Device Layer 160 and the connection events to the Network Interface Layer 170. The SPL Service Manager 260 also receives connection events from the Network Interface Layer 180 and consumes the events, or converts them into other or same device layer events and/or connection events, based on the multimedia service logic, and transmits the device layer events to the Device Layer 160 and the connection events to the Network Interface Layer 170. The SPL Service Manager 260 stores the change in state or data of the multimedia service in the SPL Service Object 310.

The SPL Interpreter 270 reads the SPL Scripts from the SPL Script Store 280 and converts each SPL Script as specified by the SPL Script Syntax, into an SPL Service Object 310. The SPL Service Object 310 is stored in the SPL Object Repository 300. The SPL Tag FunctionLibrary290 notifies the SPL Interpreter 270, if any Tag Function is added, deleted or modified, in the SPL Tag FunctionLibrary290. The SPL Interpreter 270 generates an error, if there is no corresponding SPL Tag Function available for a SPL Tag found in the SPL Script. The SPL Interpreter 270 reads the XML tags line by line and converts them into C++ objects that have variables that hold the value of the tags and the name-value attributes. These objects are stored in an SPL Object Repository 300. The SPL Object Repository 300 stores the information about the current state of the feature logic, and the interpreted information from the current SPL Script. The SPL Service Manager 260 uses the SPL Object Repository 300 to actually execute the SPL Script. The SPL Object Repository 300 stores zero or many SPL Service Objects 310. Each instance of a call or an instant messaging session needs at least one SPL Service Object 310. The instance of the call is identified by a call identifier. The call identifier uniquely identifies an SPL Service Object 310 in the SPL Object Repository 300.

The SPL Script Store 280 stores one or many SPL scripts. The SPL Tag FunctionLibrary290 stores the functions corresponding to each SPL tag. The SPL Object Repository 300 stores one or many SPL Service Objects 310.

The tag functions are packaged as a binary library and stored in a Memory 400 of the Hardware Layer 180. The Hardware layer 180 consists of a Central Processing Unit 340, a Memory 400, a Serial Link Interface Controller 350 in case of residential gateway acting as the line interface, a Digital Signal Processor 360, a Network Interface Controller 370, an I/O Controller 380 and a Control, Data and Address Bus 390.

The Central Processing Unit 340 executes the logic of the Service Layer 150, Network Interface Layer 170 and the Device Layer 160. The Memory 400 stores the logic of the Service Layer 150, Network Interface Layer 170 and the Device Layer 160 and the data generated during the execution of the logic of the Service Layer 150, Network Interface Layer 170 and the Device Layer 160. A Serial Link Interface Controller 350 performs the loop signaling with the telephone. It also converts analog voice signal to digital voice signal and transmits the digital voice signals to the Digital Signal Processor 360 and receives digital voice signal from Digital Signal Processor 360 and converts the digital voice signal to analog voice signal. The Digital Signal Processor 360 receives the digital voice signal from Serial Link Interface Controller 350 and compresses the digital voice signal into a set of voice data packets and stores them in the Memory 400. It also reads the set of voice data packets from the memory and decompresses the voice data packets to digital voice signals and transmits them to Serial Link Interface Controller 350. The Network Interface Controller 370 receives the network events from the Transport Interface Layer 190, converts the network events to physical signals, and transmits them over the Network 100. It also receives the physical signals from the Network 100 and converts them to network events and transmits them to Transport Interface Layer 190. The I/O Controller 380 receives the watchdog events defined in Watchdog-Service Manager Interface 330 from an external entity and transmits them to the Watchdog 320.

The Control, Data and Address Bus 390 connects Central Processing Unit 340 Serial Link Interface Controller 350, Digital Signal Processor 360, Digital Signal Processor 360, Network Interface Controller 370, The I/O Controller 380 and Memory 400. Control, Data and Address Bus 390 receives one or many hardware commands and/or requests from the Client Driver 220, Watchdog 320 and Transport Interface Layer 190 and transmits them to one or more of Serial Link Interface Controller 350, Digital Signal Processor 360, Network Interface Controller 350, I/O Controller 360 in case of a residential gateway and Display Controller 410, Keypad Controller 420 and Converter 430 in case of an IP Phone. It also receives hardware commands and/or requests from one or more of Digital Signal Processor 360, Network Interface Controller 370, The I/O Controller 380 and Memory 400 and transmits them to either the Client Driver 220 or Watchdog 320 or the Transport Interface Layer 190. The Central Processing Unit 340 also stores and retrieves the logic of Service Layer 150, Device Layer 160 and Network Interface Layer 170 from the Memory 400, through Control, Data and Address Bus 390.

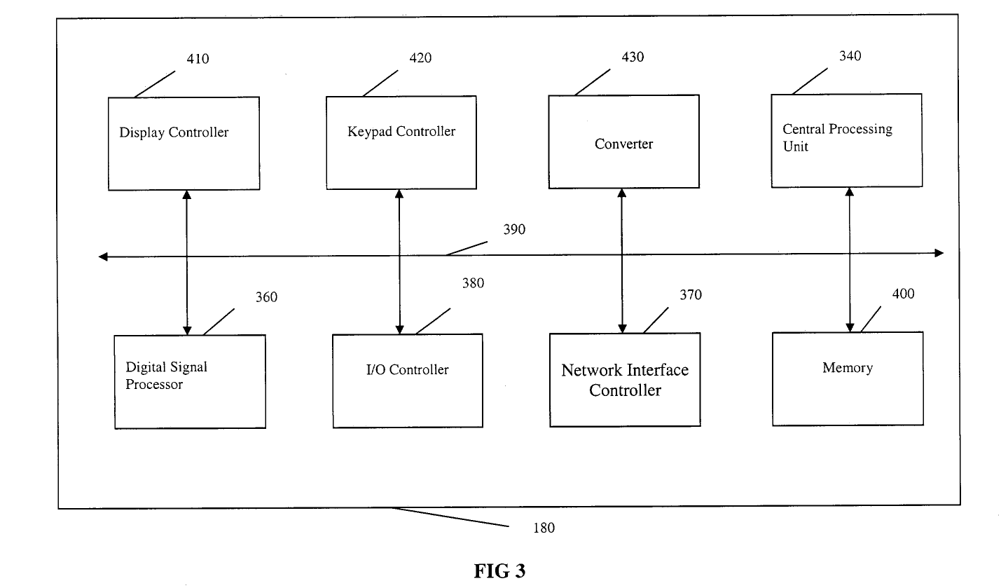

FIG. 3 illustrates the Hardware Layer 180 of an Internet Protocol (IP) Phone. In an IP phone the phone interface function is performed by three components. The Display Controller 410, the Keypad Controller 420, Converter 430. The Display Controller 410 controls a display or indicator lights on the telephone device, which can either be a LCD, LED or a video display. The Display Controller 410 displays either text, or still pictures or moving pictures or lights up or flashes in any color. The Keypad Controller 420 controls all the buttons on the face of a typical telephone. The buttons can perform any function, when pressed, and the function of the key is not defined by the Keypad Controller 420. Typically a telephone can have any number of buttons, which cannot be determined. The number of the buttons, their layout and functions are dependent on the manufacturer of the phone. The Converter 430 converts the analog voice signals into digital voice signals and converts digital voice signals or digital tone signals into analog voice signals and analog tones.

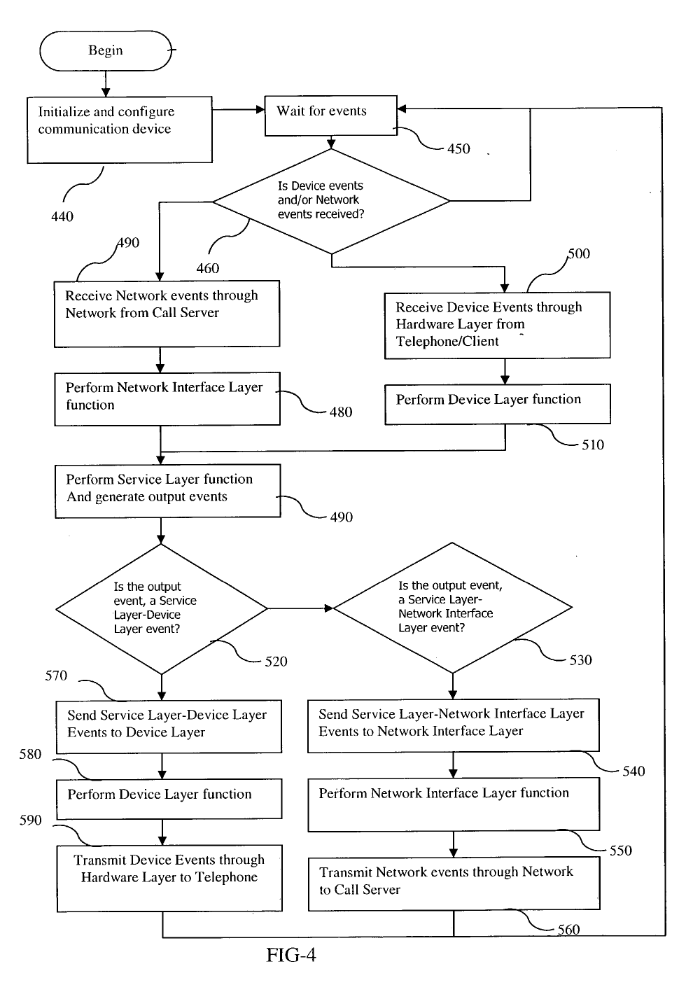

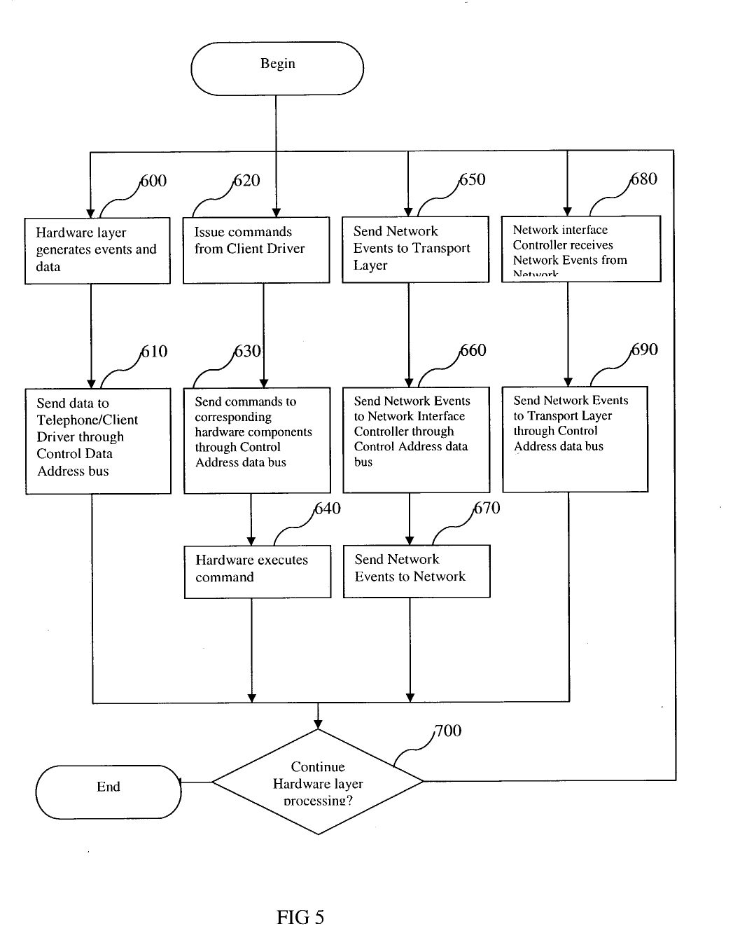

FIG. 4 illustrates the method of operation of the Communication Device 120. The communication device is embodying a computer program code, which is an XML based language. This flow chart describes the process flow performed by the communication system. The Communication Device 120 executes multimedia service logic in the Service Layer 140, and achieves the functions of the Service Layer 150. When the Communication Device 120 is enabled, it first initializes and configures the various components of the Communication Device 120 in step 440. This function is achieved by the Watchdog 320, which generates the events and the events are described by the Watchdog-Service Manager Interface 330 to the SPL Service Manager 260. The Communication Device 120 waits for device events and/or network events. The events are received in the Communication Device 120 by the Hardware Layer 180 and the Network Interface Controller 370 decides whether the event received is a network event to be passed to the Network Interface Layer 170 or a device event to be passed to the Device Layer 160. The Transport Interface Layer 190 in turn controls the functioning of the Network Interface Controller 370, and the Device Layer 160 in turn controls the functioning of the I/O Controller 380, Digital Signal Processor 360 and the Serial Link Interface Controller 350. When a communication device 120 receives a device event, step 500 is executed, and when it receives a network event, step 470 is executed. If ‘No’ event is received, then step 450 is executed wherein the system continues to wait for events. In step 500, the device event is received by the Device Layer 150 from the device through the Hardware Layer 180. In the next step 510, the functions of the Device Layer 150 are performed specified as in FIG. 5. The device event is converted into the Service Layer-Device Layer Interface Event in the Device Layer 160.

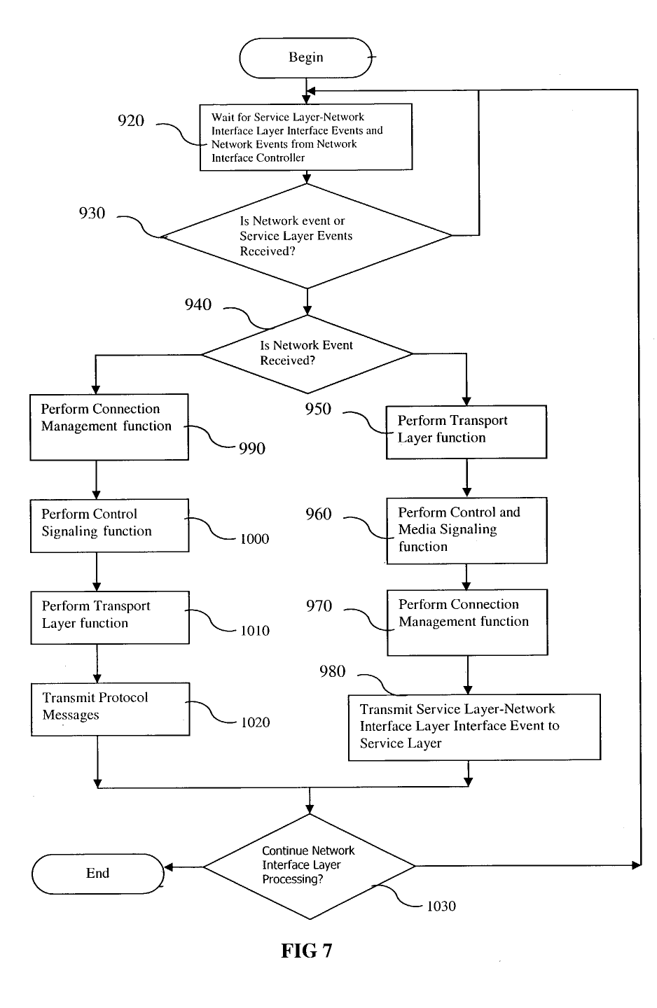

In step 470, the network event is received by the Network Interface Layer 160 from the Hardware Layer 180 received through the Network 100 from the Call Server 110. The communication device 120 subsequently executes step 480, which performs the functions of the Network Interface Layer 170 specified in FIG. 7. The network event is converted into the Service Layer-Network Interface Layer Interface Event in the Network Interface Layer 170.

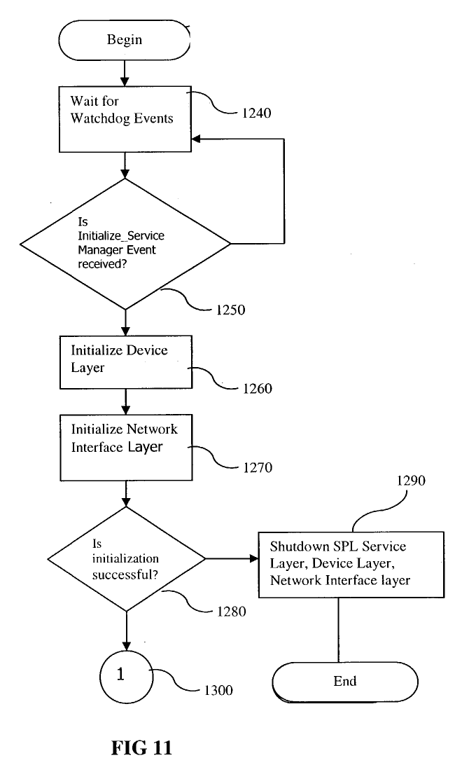

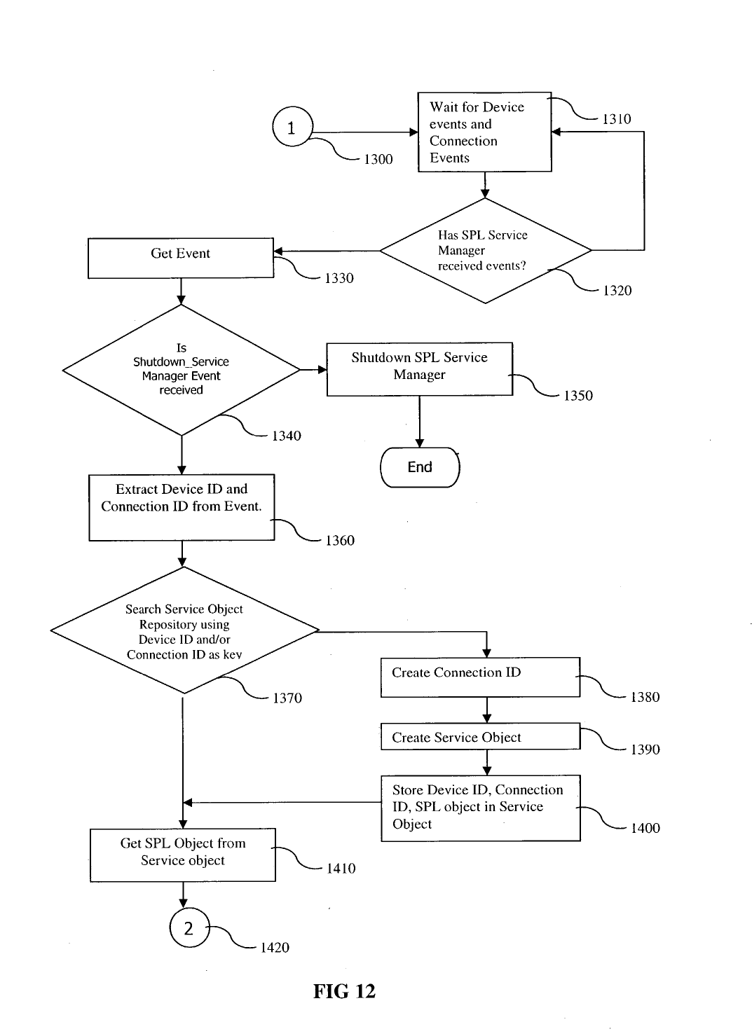

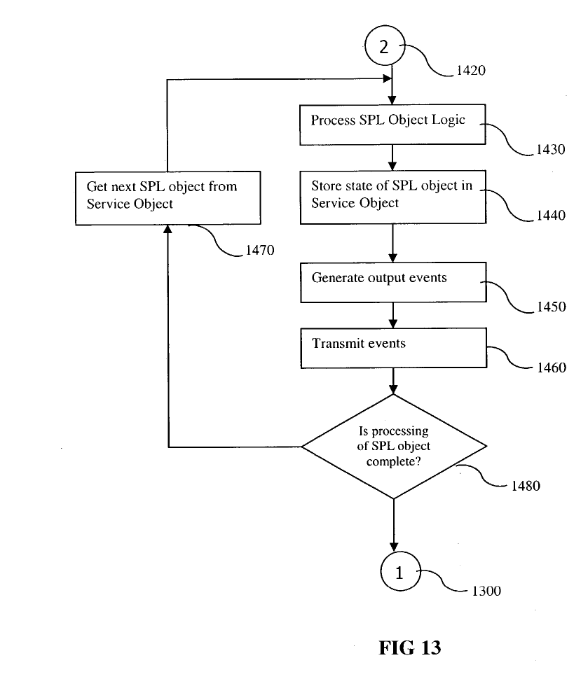

In step 490, the Service Layer 150 performs the functions of the SPL Service Manager 250 as specified in FIG. 11, FIG. 12, and FIG. 13. The Service Layer 150 generates either Service Layer-Network Interface Layer event or Service Layer-Device Layer event based on the type of event received. If the Service Layer 150 generates a Service Layer-Network Interface Layer event, then the step 520 returns “No” and executes step 530.

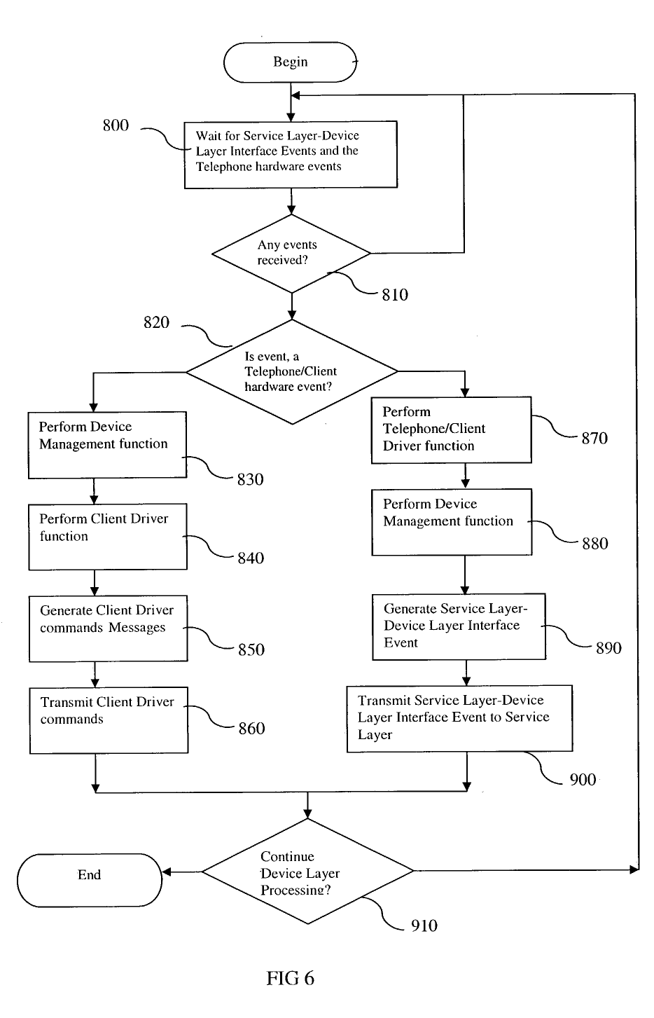

If the Service Layer 150 generates a Service Layer-Device Layer event, then the Decision Box 520 returns “Yes” and executes step 570. In step 570, the Service Layer-Device Layer events are sent to the Device Layer 160. Step 580 executes after step 1560. In step 580, the device layer function is performed as specified in FIG. 6. The device layer function converts the Service Layer-Device Layer Interface event, into a device event. In step 590, the device events are transmitted to the Telephone Device 140 though the Hardware Layer 180.

If the Service layer 150 generates a Service Layer-Network Interface Layer event, then the step 520 returns “No” and executes step 530. The step 530, decides if the output event is a Service Layer-Network Interface Layer Interface event. If the output event is a Service Layer-Network Interface Layer Interface event, step 530 returns “Yes” and executes step 540. In step 540, the Service Layer-Network Interface Layer Interface events are sent to the Network Interface Layer 170. In step 550, the Network Interface layer 170 performs the function of the Network Interface Layer 160 as specified in FIG. 7. The Network Interface Layer function then converts the Service Layer-Network Interface Layer Interface event, into a Network event. In step 560, the network events are transmitted to the Network 100 though the Hardware Layer 180 by the Network Interface Controller 370. The system thus processes the events and generates output events by realizing the logic of various multimedia services.

FIG. 5 describes the working of the Hardware Layer 180. The Hardware Layer 180 works based on commands from the Client Driver 210 and/or the Transport Interface Layer 190 or flow of data from the Hardware Layer 180 to the Client Driver 220 and/or the Transport Interface Layer 190. The commands are sent over a Control, Data and Address Bus 390 as digital signals to Serial Link Interface Controller 350, Digital Signal Processor 360, a Network Interface Controller 370, I/O Controller 380 in case of a residential gateway and in conjunction with the Display Controller 410, the Keypad Controller 420, Converter 430 in the case of IP Phone.

In the first path of execution, the step 600, is executed when one or more of the components, the Serial Link Interface Controller 350, the Digital Signal Processor 340, the Network Interface Controller 350 or the I/O Controller 360 generate data or events in case of a Residential Gateway, Display Controller 410, the Keypad Controller 420, Converter 430 in the case of an IP Phone. When the data or events are generated, the step 610 is executed. In this step, the data or events collected is sent over Control, Data and Address Bus 390 to the Client Driver 220 executing in the Central Processing Unit 340. The flow chart executes step 700 after step 610. If the Hardware Layer continues to operate, the step 700 will return “Yes”. The flow chart execution starts again if step 700 returns “Yes”. If the Hardware Layer does not continue to operate, the step 700 will return “No”, and the flow chart moves to step 710 titled “End”.

In the second path of execution, step 620 executes, when the Client Driver 220 issues one or more commands. The step 630 is executed, once the step 620 is completed. In step 630, the commands are sent to the one or more of hardware components Serial Link Interface Controller 350, Digital Signal Processor 360, a Network Interface Controller 370, I/O Controller 380 in case of a Residential Gateway and Display Controller 410, Keypad Controller 420, Converter 430 in the case of IP Phone, through the Control, Data and Address Bus 390. When the hardware component receives the commands, step 640 is executed. In this step, the hardware component (Serial Link Interface Controller 350, Digital Signal Processor 360, a Network Interface Controller 370, I/O Controller 380 in case of a Residential Gateway and Display Controller 410, Keypad Controller 420, Converter 430 in the case of IP Phone) performs the actions corresponding to the command. The flow chart executes step 700 after step 640. If the Hardware Layer 180 continues to operate, the step 700 will return “Yes” and the flow chart execution starts again. If the Hardware Layer 180 does not continue to operate, the step 700 will return “No”, and the flow chart ends.

In the third path of execution, step 650 executes, when the Transport Interface Layer 190 sends a network event to the Network Interface Controller 370. The step 660 is executed, once the step 650 is completed. In step 660, the network events are sent to the Network Interface Controller 370, through the Control, data and address bus 390. When the Network Interface Controller 370 receives the network events, step 490 is executed. In this step, the Network Interface Controller 370 sends the network event to the Network 100. If the Hardware Layer 180 continues to operate, the step 700 will return “Yes” and the flow chart execution starts again. If the hardware layer 180 does not continue to operate, the step 700 will return “No”, and the flow chart ends.

In the fourth path of execution, step 680 executes, when the Network Interface Controller 370 receives a network event from the Network 100. The step 690 is executed, once the step 680 is completed. In step 690, the network events are sent to the Transport Interface Layer 190, through the Control, data and address bus 390. The flow chart executes step 700 after step 690. If the Hardware Layer 180 continues to operate, the step 700 will return “Yes” and the flow chart execution starts again. If the Hardware Layer 180 does not continue to operate, the step 700 will return “No”, and the flow chart ends.

FIG. 6 represents the working of the Device Layer 160. The Device Layer 160 consists of the Device Manager 230 and the Client Driver 220. The Device Layer 160 waits for events from the Service Layer-Device Layer Interface 240 and device events from the Hardware Layer 180. The decision box step 810 returns “Yes”, if any events are received, and returns “No”, if no events are received. The flow chart executes step 820, if the step 810 returns “Yes”. The flow chart executes step 800 if the step 810 returns “No”. In the next step 820, a decision box decides whether the event received is a Telephone/Client Hardware event. The decision box step 820 returns “Yes” if the event is a Telephone/Client Hardware event and the flow chart moves to step 870. The decision box step 820 returns “No” if the event is a Service Layer-Device Layer Interface 240 event and the flowchart steps to 830.

In step 870, the Client Driver 220 converts the hardware data and events to software data and events. Subsequently, in step 880 the Device Manager 230 performs the Device Management function and converts the software data and events into Service Layer-Device Layer Interface 230 events. The step 890 generates the Service Layer-Device Layer Interface events. In the next step 900, the Service Layer-Device Layer Interface event is transmitted to the Service Layer 150. The next step 910 will return “Yes”, if the Device Layer 160 processing is to be continued, and the flow chart will move to step 800. If the Device Layer 160 processing is not to be continued, the step 910 will return “No” and the flow chart will end.

The flow chart moves to step 830 if the decision box step 820 returns “No”. In step 830, the Device Manager 230 performs the function and converts the Service Layer-Device Layer Interface events into a set of software data and events. Subsequently, in step 840, the Client Driver 220 converts the software data and events into hardware data and events. In the next step 850, the Service Layer-Device Layer Interface events are generated. In the next step 860, the device events are transmitted to the hardware components Serial Link Interface Controller 350, Digital Signal Processor 360, I/O Controller 380 in case of Residential Gateway and to Display Controller 410, Keypad Controller 420, Converter 430 in the case of IP Phone, through the Control, Address and Data Bus 390 and the network events are transmitted to the Network Interface Controller 370 in the Hardware Layer 180. In the next step 910, if the Device Layer 160 processing is to be continued, step 910 returns “Yes” and the flow chart will move to step 800. If the Device Layer 160 processing is not to be continued, step 910 returns “No” and the flow chart will end.

FIG. 7 represents the logic of the workings of the Network Interface Layer 170. The Network Interface Layer 170 consists of the Connection Manager 210, the Control and Media Signaling Protocol Layer 200, and the Transport Interface Layer 190. The Network Interface Layer 170 waits for connection events from the Service Layer-Network Interface Layer Interface 250 and network events from the Network Interface Controller 370. Step 920 executes and leads to step 930. The decision box step 930 returns “Yes”, if any events or messages are received, and returns “No”, if no events are received. The flow chart executes step 940, if the step 930 returns “Yes”. The flow chart executes step 920 if the step 930 returns “No”. In the next step 940, a decision box decides whether a network event is received. The decision box step 940 returns “Yes” if a network event is received. The decision box step 940 returns “No” if a Service Layer-Network Interface Layer Interface event is received.

The flow chart moves to step 950, if the decision box step 940 returns “Yes”. In step 950, the Transport Interface Layer 190 converts the network events into Control and Media Signaling Protocol Messages 130. Subsequently, in step 960, the Control and Media Signaling function converts the Control and Media Signaling protocol messages into Connection Management events. In the next step 970, the Connection Manager 210 performs the Connection Management function and converts the Connection Management events into Service Layer-Network Interface Layer Interface events. In next step 980, the Service Layer-Network Interface Layer Interface event is transmitted to the Service Layer 150. In the next step 1030, if the Network Interface Layer 170 processing is to be continued, the step 1030 returns “Yes”, and the flow chart will move to step 920. If the Network Interface Layer 170 processing is not to be continued, step 1030 will return “No” and the flow chart will end. The flow chart moves to step 990, if the decision box step 940 returns “No”. In step 990, the Connection Manager 210 performs the Connection Management function and converts the Service Layer-Network Interface Layer Interface events into Connection Management events. Subsequently, in step 1000, the Control and Media Signaling function converts the Connection Management events into Control and Media Signaling protocol messages 130. In step 1010, the Transport Interface Layer 190 converts the Control and Media Signaling protocol messages 130 into network events. In next step 1020, the network events are transmitted to the Network Interface Controller 370. In the next step 780, if the Network Interface Layer 170 processing is to be continued, step 1030 returns “Yes”, and the flow chart will move to step 920. If the Network Interface Layer 170 processing is not to be continued, step 1030 returns “No”, and the process flow will end.

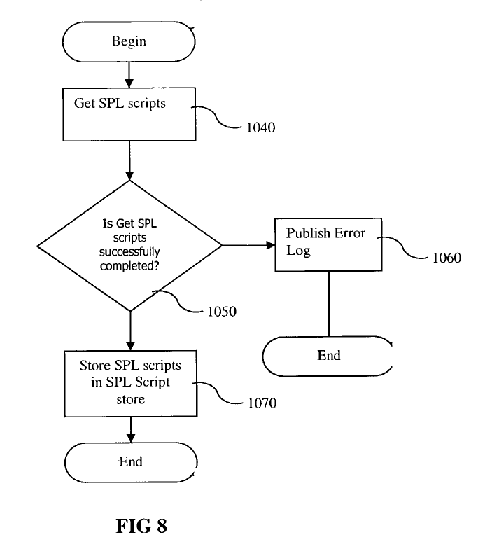

FIG. 8 describes the “SPL Script Store function” performed by the SPL Script Store 280. The flow chart shows the logic of “SPL Script Store function.” The step 1040 gets the SPL Scripts from the Memory 400 of the Communication Device 120. The SPL Scripts are stored in a text file format, in the memory 400. The next step 1050 checks whether the step 1040 is successfully completed. This step will generate either “Yes” or “No” as output. The flow chart will execute Step 1060, if the output is “No”. The flow chart will execute Step 1070, if the output is “Yes”. The step 1060 generates an error log. The error log consists of information about the error in the SPL scripts. After the error log is generated, the flowchart will end. The step 1070 stores the validated SPL script(s) in the SPL script store 280.

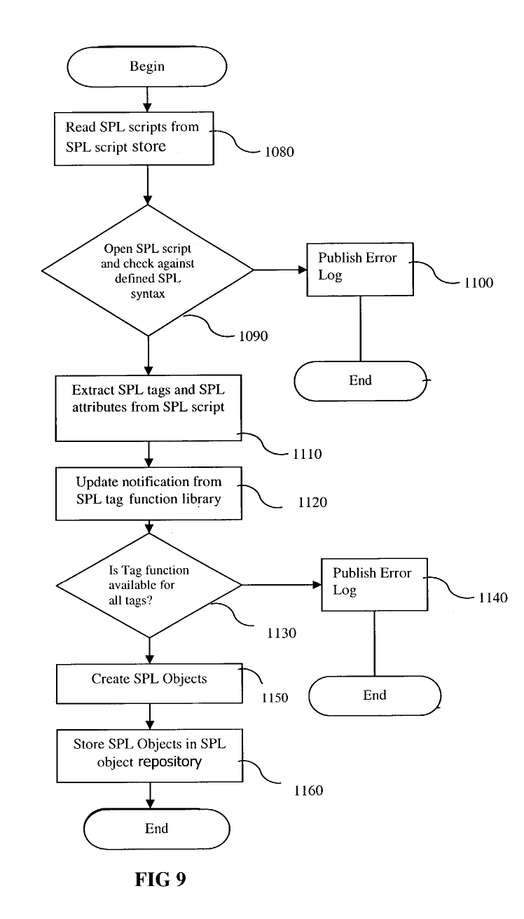

FIG. 9 describes the “SPL Interpreter function” performed by the SPL Interpreter 270. The flow chart shows the logic of “SPL Interpreter function”. The step 1080 gets the SPL Scripts from the SPL Script store 280. The SPL Scripts are stored in a text file format, in the Memory 400. The step 1090 validates the syntactic correctness of the SPL Script. This step will generate either “Correct Syntax” or “Incorrect Syntax” as output. The flow chart will execute Step 1100, if the output is “Incorrect Syntax”. The flow chart will execute Step 1110, if the output is “Correct Syntax”. The step 1100 generates an error log. The error log consists of information about the error in the SPL Scripts. After the error log is generated, the flowchart will end. The step 1110 extracts the list of SPL Tags and SPL attributes from the SPL Script. The step 1120 checks for any update notification from the SPL Tag Function Library 290. If there is any notification from the SPL Tag Function Library 290, the list of available tag functions is updated in the SPL Interpreter 270. The next step 1130 reads the list of SPL tags and SPL attributes and the list of available tag functions, and checks whether an equivalent Tag Function is available for every SPL tag in the SPL Tag Function Library 290. This step will generate either “Yes” or “No” as output. The flow chart will execute Step 1140, if the output of Step 1130 is “No”. The flow chart will execute Step 1150, if the output of Step 1130 is “Yes”. The “Publish Error Log” step 1140 generates an error log. The error log consists of information about the tags for which the corresponding Tag Function was not found. After the error log is generated, the flowchart will end. The “Create SPL objects” step 1150 creates the SPL objects corresponding to every SPL script that is interpreted by the SPL Interpreter 270. An SPL object holds the logical flow, the tags and attributes, and data of one multimedia service, contained in one SPL script. The “Store SPL objects in SPL Object Repository” step 1160 stores the created SPL objects in the SPL object repository 300. The SPL object repository 300 stores one or many SPL objects.

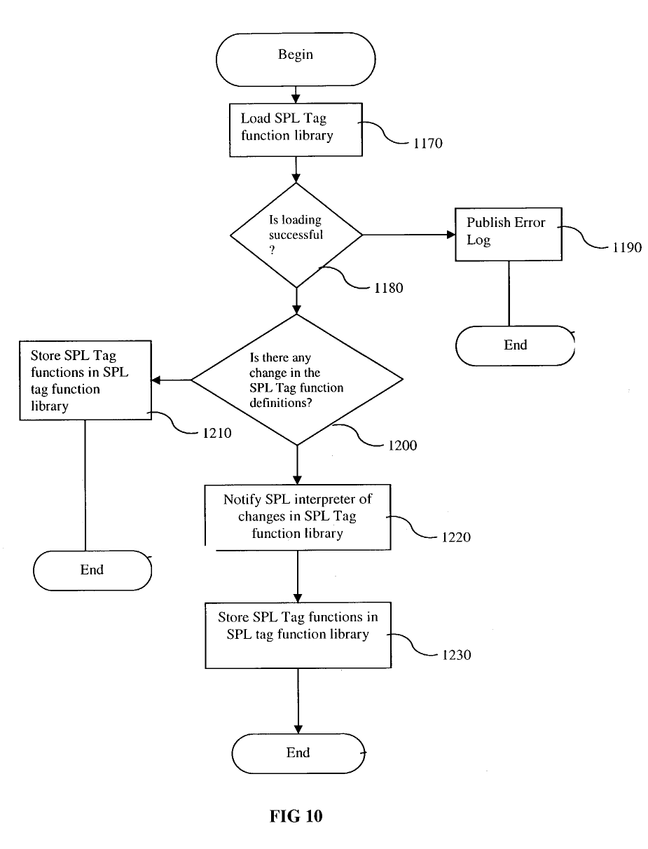

FIG. 10 describes the “SPL Tag Function” performed by the SPL Tag Function 290. The flowchart shows the logic of “SPL Tag Function”. The “Load SPL Tag Function” step 1170 stores the list of existing tag functions contained in the existing Tag Function in the Memory 400, and stores the list of new tag functions contained in the new Tag Function Library in the Memory 400. The step 1180 “Is loading successful” checks whether the loading of all the SPL tag functions has been performed accurately and successfully without any errors. This step will generate either “Successful” or “Unsuccessful” as output. The flow chart will execute Step 1190, if the output is “Unsuccessful”. The flow chart will execute Step 1200, if the output is “Successful”. The “Publish Error Log” step 1190 generates an error log. The error log consists of information about the data collected during loading unsuccessfully. After the error log is generated, the flowchart will end. The decision box step 1200 “Is there any change in the SPL Tag Function definitions?” compares the list of existing tag functions, and the new tag functions. If the list of new Tag functions consists of new, modified, or deleted Tag functions, then the step 1200 generates “Yes” and executes step 1220. If the list of new Tag functions and the list of existing Tag functions are the same, then the step 1200 generates “No” and executes step 1210.

In step 1210, the SPL tag functions are stored in the memory of the Communication System. The new SPL Tag Functions are stored in a binary format, in the memory 400.

In step 1220, the SPL Interpreter 270 is notified of the list of new Tag Functions. In step 1230, the SPL Tag Functions are stored in the memory 400 of the communication device.

FIG. 11, FIG. 12 and FIG. 13 illustrate the method of operation of the “SPL Service manager”. The “Wait for Watchdog Events” step 1240 waits for watchdog events from the Watchdog 320 through the Watchdog-Service Manager interface 330. The decision box “Is Initialize_Service Manager Event received?” step 1250 checks for the events from the Watchdog 320. This step generates either “Yes” or “No” as output.

The flow chart executes step 1240 if the output of step 1250 is “No”. The flow chart executes step 1260 if the output of step 1250 is “Yes”. The “Initialize device layer” step 1260 initializes the Device Manager 230 and the Client Driver 220 of the Device Layer 160. This step involves re-setting the hardware components Serial Link Interface Controller 350, Network Interface Controller 370, Digital Signal Processor 360 and the I/O Controller 380. in case of a Residential gateway and Display Controller 410, Keypad Controller 420, Converter 430 in the case of IP Phone. The “Initialize network interface layer” step 1270 initializes the Connection Manager 210, Control and Media Signaling Protocol Layer 200 and the Transport Interface Layer 190. This step 1270 involves the re-setting the listening ports of the Transport Interface Layer 190 and re-setting the connections in the Connection Manager 210. The step 1280 “Is initialization successful?” checks the status of the initialization of the Device Layer 160 and the Network Interface Layer 170 as described in step 1260 and step 1270. This step 1160 will generate either “success” or “failure” as output. The flow chart will execute step 1290 if the output of step 1280 is “failure”. The flow chart will execute step 1300 if the output of step 1280 is “success”. The “shutdown SPL Service Layer, Device Layer and the Network Layer” step shuts down the Device Layer 160 and the Network Interface Layer 170 and the Service Layer 150. The step moves to the end of the flow chart. The “Wait for Device events and Connection Events” step 1310 waits for device layer events from the Device Layer 160 through the Service Layer-Device Layer Interface 240 and the connection events from the Network Interface Layer 170 through the Service Layer-Network Interface Layer Interface 250. The “Has SPL Service Manager received events? step 1320 checks if an event has been received by the SPL Service Manager 260. This step will generate either “Event generated” or “No event” as output. If the output of step 1320 generates “No event” the flow chart executes step 1310. If the output of step 1320 is “Event generated” the flow chart executes step 1330. The “Get Event” step 1330 gets the event from the Device Layer 160 or the Network Interface Layer 170. The “Is Event a shutdown_service_manager event? step 1340 checks if the event received is shutdown_service_manager event. This step will generate either a “Yes” or “No” as output. The flow chart will execute the step 1360 if the output of step 1340 is a “Yes”. The flow chart will execute step 1350 if the output of step 1340 is a “No”. The “Extract Device ID and Connection ID from Event” step 1360 examines the event received from the Device Layer 160 and/or the Network Interface Layer 170. The Device ID and the Connection ID are extracted from the event. The “Shut down SPL Service manager” step 1350 shuts down the SPL Service Manager 260. The flow chart will then end.

The “Search service Object using Device ID and/or Connection ID as key” step 1370 searches the list of Service objects in the memory 400 of the SPL based communication system 120 using the Device id and/or Connection id as input for the search. If the input Device id and/or Connection id matches the Device id and/or Connection id of a service object, step 1370 generates “service object found” as output. If the input Device id and/or Connection id does not match the Device id and/or Connection id of a service object, step 1370 generates “service object not found” as output. The flow chart executes step 1410 if the output of step 1370 generated is “service object found”. The flow chart executes step 1380 if the output of step 1370 generated is “Service object not found”. The “Get SPL Object from Service object” step 1410 gets service object from the memory 400 of the SPL based communication system. The “Create Connection ID” step 1380 creates a connection id using a number generation method to uniquely identify a connection. The “Create service Object instance” step 1390 creates a new Service object. The “Store Device ID and Connection ID in service Object” step 1400 populates the service object created in step 1390 with the device id and the connection id. The step 1400 moves to step 1410. No logic is executed in Step 1420. The “Process SPL Object logic” step executes the logic from the SPL object obtained from the Service object. This step executes the multimedia service logic contained in the SPL object.

The multimedia service logic executes and either generates no Output events or generates connection events to the Network Interface Layer 170 as defined by the Service Layer-Network Interface Layer interface 250 and/or device layer events to the Device Layer 160 as defined by the Service Layer-Device Layer interface 240. The multimedia service logic is a sequence of steps that are executed by the SPL Service Manager 260 to achieve the logic of a multimedia service.

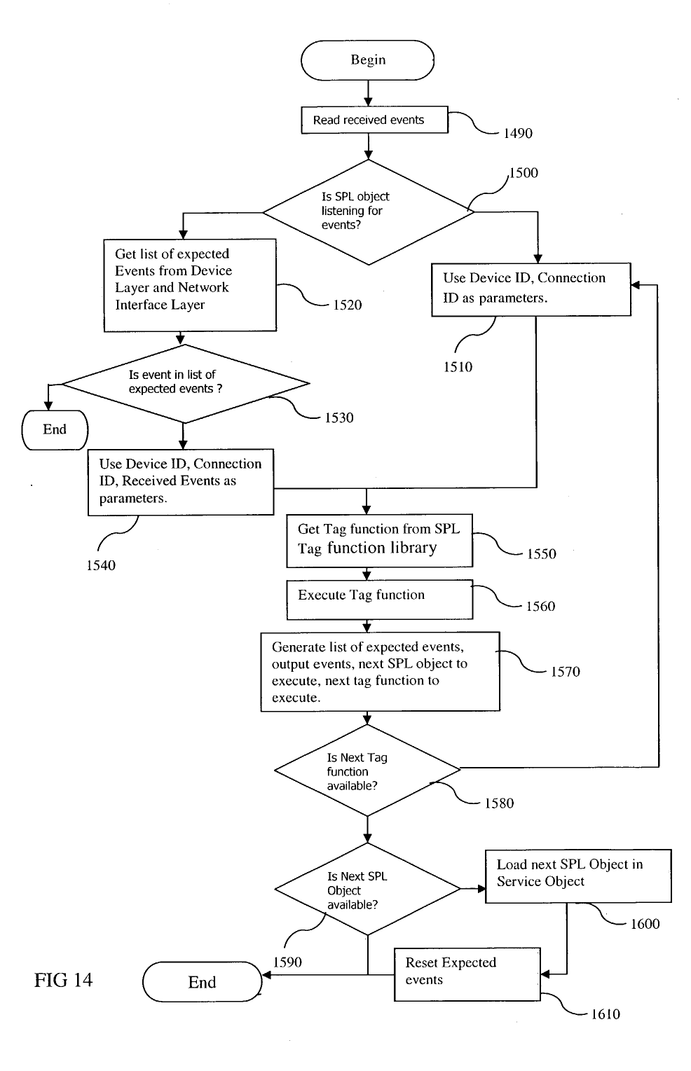

A typical list of multimedia services include call transfer, call forward, call logs. The “Store state of SPL object in Service Object” step 1440 stores the state of the SPL object in the Service object. The state of the SPL object defines the next logical step to be executed to perform the multimedia service logic and the data needed to perform the multimedia service logic. The “Generate Output Event” step 1450 generates an Output event to the device layer or the network interface layer and stores it in the memory 400 of the SPL based communication system. Step 1460 executes after step 1450. The “Transmit events” step 1460 transmits the device layer events to the Device Layer 160 or the connection events to the Network Interface Layer 170. The flow chart executes the step 1480 after the transmission of events to the Device Layer 160 or the Network Interface Layer 170. In the step 1480, “Is processing of SPL object complete?” checks if the logic contained in the SPL object has been completely processed. This step generates either “Yes” or “No” as output. If the SPL object that was given as input to step 1430 is still being executed, then the output of step 1480 is “No” and executes the step 1300. If the SPL object that was given as input in step 1430 is completed, and a new SPL object has been loaded in the Service object, then the output of step 1480 is “Yes”, and executes step 1470. In step 1470, the SPL Service Manager function gets the next SPL object that was loaded into the memory 400 of the SPL enabled communication device 120 in step 1600 in FIG. 14. Subsequent to step 1470, the next SPL object is processed in step 1430, and the flow chart executes the sequence of steps 1440, 1450 and 1460, until the step 1480 returns a “Yes” and executes step 1300.

The FIG. 14 represents the logic performed in step 1430 of FIG. 13. The functionality of the step 1430 of FIG. 13 is explained in steps 1490 to 1610 in FIG. 14.

The step 1490 “Read Received events” reads the events from the Service Layer-Network Interface Layer Interface 250 and/or the Service Layer-Device Layer Interface 240. The events received will be case-specific, like handling of an incoming call or for an execution of a call-waiting feature. The decision box 1500 “Is SPL object listening for events?” checks if the SPL object is expecting an incoming event as defined in the logic of the SPL script. The step 1500 generates either “Yes” or “No” as output. The flow chart moves to step 1520 if the output of step 1500 is “Yes”. The flow chart moves to step 1510 if the output of step 1500 is “No”.

The step 1520 “Get list of expected Events from Device Layer 160 and Network Interface Layer 170 gets the list of events which are expected by the SPL object 310 to be handled in the current cycle of execution. The list of expected events is based on the logic being executed in the SPL Script. (For e.g, in an Outgoing Call multimedia service, the SPL script requests the Device Layer 160 to collect and transmit the Offhook event to the SPL Service Manager 260, when the Telephone/Client goes offhook. The logic of the SPL script specifies Offhook as an expected event, and subsequently executes a tag function, when the Offhook event is received by the SPL Service Manager 260). The step 1530 “Is event in list of expected events?” compares the expected events with the event received from the Service Layer-Network Layer Interface 250 and/or the Service Layer-Device Layer Interface 240. The step 1520 generates “Yes” or “No” as output. The flow chart executes step 1540 if the output of step is “Yes”. The flow chart will end output of step 1530 is “No”. The step 1540 “Use Device ID, Connection ID, Received Events as parameters” collects the information required to execute the Tag Function from the SPL Tag Function Library 290.

The step 1510 “Use Device ID, Connection ID as parameters” collects the information required to execute the Tag Function from the SPL Tag Function Library 290. The step 1550 “Get Tag Function from SPL Tag Function Library” gets the tag function, which needs to be executed from the SPL Tag Function Library 290.

The next step 1560 “Execute Tag function” executes the Tag Function with the parameters collected in either step 1540 or step 1510. The step 1570 “Generate list of expected events, output events, next SPL object to execute, next Tag Function to execute” generates actions to continue the SPL object processing. The various actions that result from step 1570 depend on the type of tag that was executed. The step 1570 will result in either device layer events to the Device Layer 160 or connection events to the Network Interface Layer 170, or a list of expected events from the Device Layer 160 or the Network Interface Layer 170, or continue execution logic in the SPL object by executing the next SPL Tag Function or load the next SPL object to be executed.

The next step 1580 “Is Next Tag Function available” checks if another Tag Function exists to be executed in the SPL object. This check ensures that all tags in an SPL object are executed in sequence before moving to the next step 1590. The step 1580 generates either “Yes” or “No” as output. The flow chart executes step 1510 if the output of step 1580 is “Yes”. The flow chart executes step 1590 if the output of step 1580 is “No”. The step 1590 “Is Next SPL Object available” checks if the next SPL object is available in the Service Object. This step 1590 generates either “Yes” or “No” as output. The flow chart executes step 1600 if the output of step 1590 is “Yes”. The flow chart executes ends if the output of step 1590 is “No”.

The step 1600 “Load next SPL Object in Service Object” loads the next SPL object from the Service object. Step 1610 executes after step 1600. Step 1610 resets the expected event list, since a new SPL object is now loaded. If the output of step 1590 is “No” the flow chart ends which completes the logic of the step 1350 “Process SPL object logic” of FIG. 13, and the execution moves to step 1440 of FIG. 12.

While various embodiments of the invention have been described in detail with reference to certain specific embodiments, it should be appreciated that the present invention is not limited to those precise embodiments. Rather, in view of the present disclosure, which describes the current best mode for practicing the invention, many modifications and variations would present themselves to those of skill in the art without departing from the scope and spirit of this invention.

We claim:

1. A communication system embodying a computer program code configurable to provide multimedia services, the communication system comprising:
a call server configured to define a control and media signaling protocol;
a plurality of communication devices configured to communicate with the call server through a network; the communication system configured to provide at least one of the plurality of multimedia services selected from a group of services.

2. The communication system embodying a computer program code configurable to provide multimedia services according to claim 1 wherein the group of multimedia services consists essentially of call forwarding, call transfer, notification service, messaging, call waiting, video conference, video and voice call, video or voice call, exchange of data during an active video and voice call, exchange of data during an active video or voice call, exchange of data during conference, third party call control and hotline services.

3. A communication system according to claim 1, further comprising a telephone device coupled to the communication device.

4. A communication system according to claim 3 wherein the system configured to implement at least one of the plurality of the multimedia services in residential gateways.

5. The communication system according to claim 1 wherein the communication device comprises a IP Phone.

6. The communication system according to claim 1 wherein the Call Server is configured to implement call-processing requests and responses from at least one of the plurality of the Communication Devices.

7. The communication system according to claim 3 wherein the telephone device is configured to communicate with any of the plurality of the communication devices.

8. The communication system according to claim 1 wherein the call server defines a control and media signaling protocol configured to carry requests and response to establish, modify, destroy and manage multimedia sessions and media packets from any of the plurality of the communication devices to the network and from the network to any of the plurality of the communication devices.

9. A communication device embodying computer program code configurable to provide at least one of the plurality of multimedia services, the communication device comprising:
a hardware layer,
a network interface layer,
a device layer, and
a service layer, wherein:
the hardware layer has:
a serial line interface controller configured to perform loop signaling;
a memory configured to host the network interface layer, the device layer and the service layer;
a central processing unit configured to execute a logic contained in the network interface layer, the device layer and the service layer;
a network interface controller configured to receive network events;
an I/O Controller configured to receive watchdog events;
a digital signal processor configured to compress and decompress voice samples;
the device layer has:
a device manager configured to manage multiple telephone devices;
a client driver configured to convert device events to software events and software events to device events;
the network interface layer has:
a connection manager configured to manage state of connections in the communication device;
a control signal protocol interface layer configured to format connection requests into a control signal protocol;
a transport interface layer configured to convert control signal protocol into a network event;
the service layer has:
a Watchdog configured to initialize or shutdown a Service Manager;
an SPL Script Store configured to store SPL Script;
an SPL Interpreter configured to read the SPL Script stored in the SPL Script Store and convert the SPL Script into SPL Objects;
an SPL Object Repository configured to store the SPL Objects;
an SPL Service Manager configured to process multimedia services;
an SPL Tag Function Library configured to notify the SPL Interpreter of any change in the Tag Functions; wherein the communication device configured to provide at least one of the plurality of the multimedia services selected from a group of multimedia services.

10. The communication device embodying a computer program code configurable to provide multimedia services according to claim 9 wherein the group of multimedia services consists essentially of call forwarding, call transfer, notification service, messaging, call waiting, video conference, video and voice call, video or voice call, exchange of data during an active video and voice call, exchange of data during an active video or voice call, exchange of data during conference, third party call control and hotline services.

11. The Communication Device according to claim 10 wherein the device is configured to implement at least one of the plurality of the multimedia services in IP Phones.

12. The Communication Device according to claim 10 wherein the device is configured to implement at least one of the plurality of the multimedia services in residential gateways.

13. A Communication Device according to claim 12, the device comprising a Service Layer has:
a Watchdog configured to initialize or shutdown an SPL Service Manager;
an SPL Script Store configured to store SPL Script;
an SPL Interpreter configured to interpret the SPL Script;
an SPL Object Repository configured to store SPL Objects corresponding to the SPL Script;
an SPL Service Manager configured to process multimedia services;
an SPL Tag Function Library configured to notify the SPL Interpreter of any change in the Tag Functions, multimedia services; wherein the Service Layer is configured to enable the Communication Device to process incoming network events in residential gateways.

14. A Communication Device according to claim 11, the device comprising a Service Layer has:
a Watchdog configured to initialize an SPL Service Manager;
an SPL Script Store configured to store SPL Script;
an SPL Interpreter configured to interpret the SPL Script;
an SPL Object Repository configured to store SPL Objects corresponding to the SPL Script;
an SPL Service Manager configured to process multimedia services;
an SPL Tag Function Library configured to notify the SPL Interpreter of any change in the Tag Functions; wherein the Service Layer configured to enable the Communication Device to process incoming network events in IP Phones.

15. The Communication Device according to claim 14 wherein the network events include an event when a call is created, an event when a call is incoming, an event when a call is timed out, an event when an error is occurred, an event when a local party is answered, an event when a local party is alerted, an event when a call is proceeded, an event when a call is established, an event when a local party is disconnected, an event when a remote party is answered, an event when a remote party is alerted, an event when a remote party is disconnected, an event when a call is on remote hold, an event when a call is on local hold, an event when a call is transferred, an event when a call is on conference, an event when call data is obtained, an event when call data is set, an event when media is enabled, an event when media is disabled, an event when a message is sent, an event when a message is received, an event when a call is notified, an event when notification is obtained, an event when user data is obtained and an event when user data is set.

16. A Communication Device according to claim 9, the device comprising a Service Layer has:
a Watchdog configured to initialize an SPL Service Manager;
an SPL Script Store configured to store SPL Script;
an SPL Interpreter configured to interpret the SPL Script;
an SPL Object Repository configured to store SPL Objects corresponding to the SPL Script;
an SPL Service Manager configured to process multimedia services;
an SPL Tag Function Library configured to notify the SPL Interpreter of any change in the Tag Functions; wherein the Service Layer configured to enable the Communication device to process at least one of the plurality of incoming device events in residential gateways.

17. A Communication Device according to claim 9, the device comprising a Service Layer has:
a Watchdog configured to initialize an SPL Service Manager;
an SPL Script Store configured to store SPL Script;
an SPL Interpreter configured to interpret the SPL Script;
an SPL Object Repository configured to store SPL Objects corresponding to the SPL Script;
an SPL Service Manager configured to process multimedia services;
an SPL Tag Function Library configured to notify the SPL Interpreter of any change in the Tag Functions; wherein the Service Layer configured to enable the Communication Device to process at least one of the plurality of incoming device events in IP Phones.

18. The Communication Device according to claim 16 wherein the device events include an event when a call is on hook, an event when a call is offhook, an event when a call is on playtone, an event when call digits are collected, an event when call text is displayed, an event when lamp state is set, an event when key press is collected, an event when speaker mode is set, an event when microphone mode is set, an event when hook switch status is obtained, an event when hook switch status is set, an event when display is obtained, an event when button information is obtained, an event when display is set, an event when lamp information is obtained, an event when dial mode is obtained, an event when dial mode is set, an event when lamp information is set, an event when lamp mode is obtained, an event when lamp mode is set, an event when message waiting indicator is obtained, an event when message waiting indicator is set, an event when microphone gain is obtained, an event when microphone gain is set, an event when ringer status is obtained, an event when ringer status is set, an event when speaker mute is obtained, an event when speaker mute is set, an event when speaker volume is obtained, an event when speaker volume is set, an event when a call is on hold, an event when flash is opted, an event when a call is on conference, an event when a call is transferred, an event when media is allocated, an event when media is attached and an event when media is detached.

19. The Communication device according to claim 18, wherein the device is configured to process multimedia services in residential gateways.

20. A communication device embodying computer program code configurable to provide at least one of the plurality of multimedia services, the communication device comprising a hardware layer, a network interface layer, a device layer, and a service layer, wherein:
the hardware layer has:
a display controller configured to display text matter or still images or moving images on a communication device;
a key pad controller configured to control key buttons on the communication device;
a converter configured to convert analog voice or video signals to digital and digital voice or video signals to analog;
an I/O controller configured to receive Watch Dog events;
a memory configured to host the network interface layer, the device layer and the service layer;
a network interface controller configured to receive network events;
a central processing unit configured to execute a logic contained in the network interface layer, the device layer and the service layer; and
a digital signal processor configured to compress and decompress voice samples;
the device layer has:
a device manager configured to manage multiple telephone devices;
a client driver configured to convert device events to software events and software events to device events;
the network interface layer having:
a connection manager configured to manage state of connections in the communication device;
a control signal protocol interface configured to format connection requests into a control signal protocol;
a transport interface layer configured to convert control signal protocol into a network event;
the service layer has:
an SPL Script Store configured to store SPL Script;
an SPL Interpreter configured to read the SPL Script stored in the SPL Script Store and convert the SPL Script into SPL Objects;
an SPL Object Repository configured to store the SPL Objects;
an SPL Service Manager configured to process multimedia services;
an SPL Tag Function Library configured to notify the SPL Interpreter of any change in the Tag Functions; wherein the Communication device is configured to process multimedia services in IP Phones.

21. A method of processing multimedia events in residential gateways employing a Communication Device, the method comprising:
receiving a network event by a Network Interface Controller from a Network;
notifying the network event through a Control, Address and Data bus to the Transport Interface Layer of a Network Interface Layer;
converting the network event into a Service Layer-Network Interface Layer Interface event by a Transport Interface Layer in conjunction with a Connection Manager and a Control and Media Signaling Protocol Layer;
receiving the network event thus converted into a Service Layer-Network Interface Layer Interface event by an SPL Service Manager;
extracting a device-id and a connection-id by an SPL Service Manager from the event;
accessing an SPL Object Repository by the SPL Service Manager to identify an SPL Object corresponding to the device-id and the connection-id received from the event, generating an SPL Output Event by the SPL Service Manager and communicating the SPL Output Event to the Network Interface Layer by the SPL Service Manager;
forwarding the SPL Output Event by the Network Interface Layer to the Network Interface Controller; and
returning the SPL Output Event by the Network Interface Controller to the Network.

22. A method of processing multimedia events in residential gateways employing a Communication device, the method comprising:
receiving a device event by a Serial Link Interface Controller in conjunction with a Digital Signal Processor from a telephone device.
notifying the device event through a Control, Address and Data bus to a Client Driver of a Device Layer;
converting the device event into a Service Layer-Device Layer Interface event by the Device Layer in conjunction with a Device Manager and a Client Driver;
receiving the device event thus converted into a Service Layer-Device Layer Interface event by an SPL Service Manager;
extracting a device-id and a connection-id by an SPL Service Manager from the event;
accessing an SPL Object Repository by the SPL Service Manager to identify an SPL Object corresponding to the device-id and the connection-id received from the event, generating an SPL Output Event by the SPL Service Manager and communicating the SPL Output Event to the Device Layer by the SPL Service Manager;
forwarding the SPL Output Event by the Device Layer to the Serial Link Interface Controller in conjunction with a digital Signal Processor; and
returning the SPL Output Event by the Serial Link Interface Controller in conjunction with a digital Signal Processor to the Telephone Device.

23. A method of processing multimedia events in residential gateways employing a Communication device, the method comprising:
receiving a network event by a Network Interface Controller from a Network;
notifying the network event through a Control, Address and Data bus to the Transport Interface Layer of a Network Interface Layer;
converting the network event into a Service Layer-Network Interface Layer Interface event by a Transport Interface Layer in conjunction with a Connection Manager and a Control and Media Signaling Protocol Layer;
receiving the network event thus converted into a Service Layer-Network Interface Layer Interface event by an SPL Service Manager;
extracting a device-id and a connection-id by an SPL Service Manager from the event;
accessing an SPL Object Repository by the SPL Service Manager to identify an SPL Object corresponding to the device-id and the connection-id received from the event, generating an SPL Output Event by the SPL Service Manager and communicating the SPL Output Event to the Device Layer by the SPL Service Manager;
forwarding the SPL Output Event by the Device Layer to the Serial Link Interface Controller in conjunction with a digital Signal Processor; and
returning the SPL Output Event by the Serial Link Interface Controller in conjunction with a digital Signal Processor to the Telephone Device.

24. A method of processing multimedia events in residential gateways employing a Communication device, the method comprising:
receiving a device event by a Serial Link Interface Controller in conjunction with a Digital Signal Processor from a telephone device.
notifying the device event through a Control, Address and Data bus to a Client Driver of a Device Layer;
converting the device event into a Service Layer-Device Layer Interface event by the Device Layer in conjunction with a Device Manager and a Client Driver;
receiving the device event thus converted into a Service Layer-Device Layer Interface event by an SPL Service Manager;
extracting a device-id and a connection-id by an SPL Service Manager from the event;
accessing an SPL Object Repository by the SPL Service Manager to identify an SPL Object corresponding to the device-id and the connection-id received from the event, generating an SPL Output Event by the SPL Service Manager and communicating the SPL Output Event to the Network Interface Layer by the SPL Service Manager;
forwarding the SPL Output Event by the Network Interface Layer to the Network Interface Controller; and
returning the SPL Output Event by the Network Interface Controller to the Network.

25. A method of processing multimedia events in IP Phones employing a Communication Device, the method comprising:
receiving a network event by a Network Interface Controller from a Network;
notifying the network event through a Control, Address and Data bus to a Transport Interface Layer of a Network Interface Layer;
converting the network event into a Service Layer-Network Layer Interface event by a Transport Interface Layer in conjunction with a Connection Manager and a Control and Media Signaling Protocol Layer;
receiving the network event thus converted into a Service Layer-Network Interface Layer Interface event by an SPL Service Manager;
extracting a device-id and a connection-id by an SPL Service Manager from the event;
accessing an SPL Object Repository by the SPL Service Manager to identify an SPL Object corresponding to the device-id and the connection-id received from the event, generating an SPL Output Event by the SPL Service Manager and communicating the SPL Output Event to the Network Interface Layer by the SPL Service Manager;
forwarding the SPL Output Event by the Network Interface Layer to the Network Interface Controller; and
returning the SPL Output Event by the Network Interface Controller to the Network.

26. A method of processing multimedia services in IP Phones employing a Communication device, the method comprising:
receiving a device event by a Serial Link Interface Controller in conjunction with a Digital Signal Processor from a telephone device;
notifying the device event through a Control, Address and Data bus to a Client Driver of a Device Layer;
converting the device event into a Service Layer-Device Layer Interface event by the Device Layer in conjunction with a Device Manager and a Client Driver;
receiving the device event thus converted into a Service Layer-Device Layer Interface event by an SPL Service Manager;
extracting a device-id and a connection-id by an SPL Service Manager from the event;
accessing an SPL Object Repository by the SPL Service Manager to identify an SPL Object corresponding to the device-id and the connection-id received from the event, generating an SPL Output Event by the SPL Service Manager and communicating the SPL Output Event to the Device Layer by the SPL Service Manager;
forwarding the SPL Output Event by the Device Layer to the Serial Link Interface Controller in conjunction with a Digital Signal Processor; and
returning the SPL Output Event by the Serial Link Interface Controller in conjunction with a Digital Signal Processor to the Telephone Device.

27. A method of processing multimedia services in IP Phones employing a Communications Device, the method comprising:
receiving a network event by a Network Interface Controller from a Network;
notifying the network event through a Control, Address and Data bus to a Transport Interface Layer of a Network Interface Layer;
converting the network event into a Service Layer-Network Layer Interface event by a Transport Interface Layer in conjunction with a Connection Manager and a Control and Media Signaling Protocol Layer;
receiving the network event thus converted into a Service Layer-Network Interface Layer Interface event by an SPL Service Manager;
extracting a device-id and a connection-id by an SPL Service Manager from the event;
accessing an SPL Object Repository by the SPL Service Manager to identify an SPL Object corresponding to the device-id and the connection-id received from the event, generating an SPL Output Event by the SPL Service Manager and communicating the SPL Output Event to the Device Layer by the SPL Service Manager;
forwarding the SPL Output Event by the Device Layer to the Serial Link Interface Controller in conjunction with a Digital Signal Processor; and
returning the SPL Output Event by the Network Serial Link Interface Controller in conjunction with a Digital Signal Processor to the Telephone Device.

28. A method of processing multimedia services in IP Phones employing a Communication device, the method comprising:
receiving a device event by a Serial Link Interface Controller in conjunction with a Digital Signal Processor from a telephone device.
notifying the device event through a Control, Address and Data bus to a Client Driver of a Device Layer;
converting the device event into a Service Layer-Device Layer Interface event by the Device Layer in conjunction with a Device Manager and a Client Driver;
receiving the device event thus converted into a Service Layer-Device Layer Interface event by an SPL Service Manager;
extracting a device-id and a connection-id by an SPL Service Manager from the event;
accessing an SPL Object Repository by the SPL Service Manager to identify an SPL Object corresponding to the device-id and the connection-id received from the event, generating an SPL Output Event by the SPL Service Manager and communicating the SPL Output Event to the Network Interface Layer by the SPL Service Manager;
forwarding the SPL Output Event by the Network Interface Layer to the Network Interface Controller; and
returning the SPL Output Event by the Network Interface Controller to the Network.

29. The method according to any of claims 21 to 28 wherein the method further comprising:
receiving a device id and a connection id from an event;
extracting an SPL object corresponding to the device id and connection id from an SPL Object Repository;
generating an event corresponding to state of the object as extracted from the SPL object Repository; and
transmitting the event thus generated to a device manager or a connection manager.

30. The method according to any of claims 21 to 29 wherein the method further comprising:
a first instance of the SPL Service Manager not generating an event;
a second instance of the SPL Service Manager generating an event;
a third instance of the SPL Service Manager generating an event and transmitting the event thus generated to a connection manager;
a fourth instance of the SPL Service Manager transmitting the event generated to a Device Manager; and
a fifth instance of the SPL Service Manager generating an event and transmitting the event to the Connection Manager and the Device Manager.
